(19) United States
(12) Patent Application Publication
(10) Pub. No.: US 2023/0237422 A1
(43) Pub. Date: Jul. 27, 2023

(54) CROSS-ORGANIZATION TRACKING IDENTIFIER SPACE ALLOCATION FOR SUPPLY CHAINS

(71) Applicant: Cisco Technology, Inc., San Jose, CA (US)

(72) Inventors: Marco TRINELLI, Lausanne (CH); Marcelo YANNUZZI, Vufflens-La-Ville (CH); Bart BRINCKMAN, Nevele (BE)

(21) Appl. No.: 17/582,432

(22) Filed: Jan. 24, 2022

(51) Int. Cl. G06Q 10/08

(52) U.S. Cl. CPC G06Q 10/0833

(57) ABSTRACT

According to one or more embodiments of the disclosure, a device receives, from a client at a first organization, a tracking identifier space allocation request for one or more physical assets. The device identifies, based on the tracking identifier space allocation request, a range of tracking identifiers that are not allocated to one or more other organizations for use. The device sends, to the client at the first organization, a tracking identifier space allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations.

### TECHNICAL FIELD

The present disclosure relates generally to computer networks, and, more particularly, to cross-organization tracking identifier space allocation for supply chains.

### BACKGROUND

In a given supply chain, tracking of shipments and inventory has conventionally been focused on proprietary solutions based on singular beacon/tag technologies, for example, Bluetooth or radio-frequency identification. These technologies oftentimes do not support roaming across different domains of a supply chain. To identify beacons/tags as they transit across the supply chain's chain of custody and to share relevant information (to upstream and downstream domains), different organizations/domains that are part of the supply chain are forced to adopt a same solution (e.g., tracking technology). In practice, however, a particular domain (e.g., carriers, warehouses, manufacturers, etc.) of a supply chain may handle shipments, goods, etc. that are “tracked” with a particular beacon/tag technology that are non-interoperable and disparate from the point-of-view of the particular domain (e.g., the goods are based on solutions using proprietary identifier allocations for a real-time location systems).

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example network;

FIG. 2 illustrates an example network device/node;

FIG. 3 illustrates an example identity federation and visibility service;

FIG. 4 illustrates an example architecture for an identity federation and visibility service;

FIG. 5 illustrates an example architecture for an open roaming registry service;

FIG. 6 illustrates an example open roaming registry service for an identity federation and visibility service;

FIGS. 7A-7B illustrate an example system that includes an open roaming registry service;

FIG. 8 illustrates an example flow diagram for an open roaming registry service;

FIG. 9 illustrates an example domain name system resolution process for enabling dynamic discovery of an identity provider and associated connector; and

FIG. 10 illustrates an example simplified procedure for providing tracking identifier space allocations as a service.

### DESCRIPTION OF EXAMPLE EMBODIMENTS

### Overview

According to one or more embodiments of the disclosure, a device receives, from a client at a first organization, a tracking identifier space allocation request for one or more physical assets. The device identifies, based on the tracking identifier space allocation request, a range of tracking identifiers that are not allocated to one or more other organizations for use. The device sends, to the client at the first organization, a tracking identifier space allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing (also known as edge computing, near edge computing, far edge computing, etc.) is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

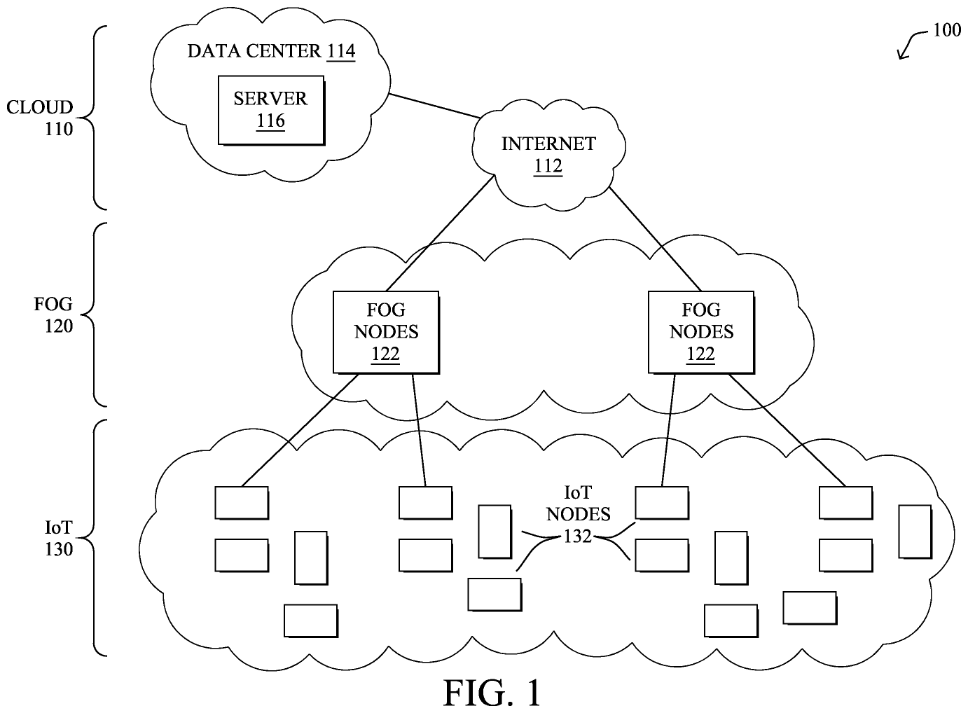

FIG. 1 is a schematic block diagram of an example simplified computer network 100 illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely cloud layer 110, fog layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT device layer 130. For example, fog nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), powerline communication protocols, or other shared-media protocols where appropriate. In this context, a protocol consists of a set of rules defining how the nodes interact with each other.

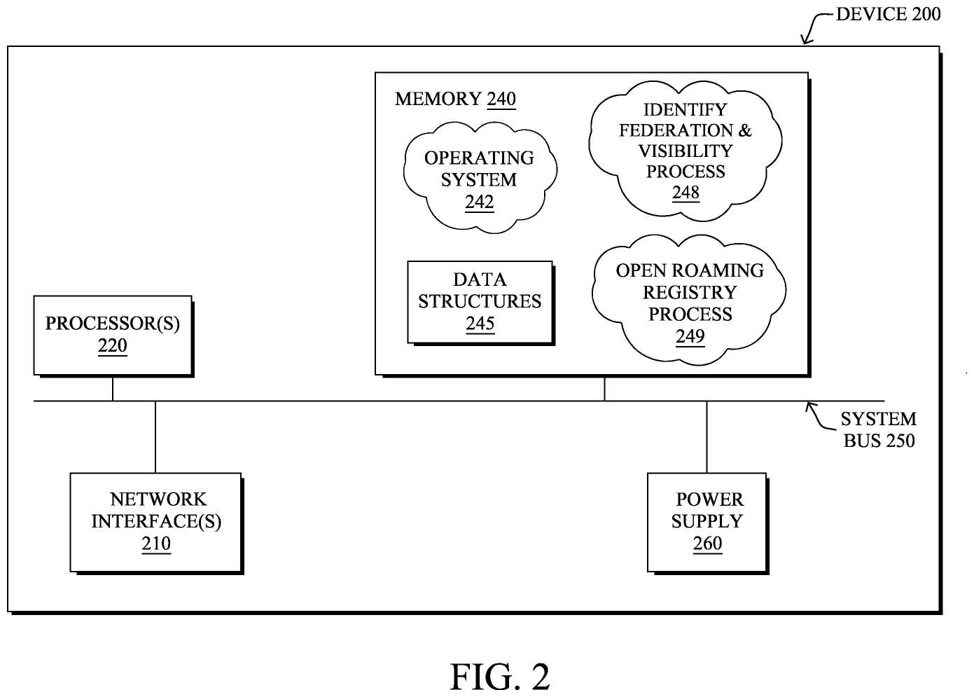

FIG. 2 is a schematic block diagram of an example node/device 200 (e.g., an apparatus) that may be used with one or more embodiments described herein. As shown, device 200 may comprise one or more communication interfaces 210 (e.g., wired, wireless, etc.), at least one processor 220, and a memory 240 interconnected by a system bus 250, as well as a power supply 260 (e.g., battery, plug-in, etc.).

Communication interface(s) 210 may be coupled to processor 220 and include the mechanical, electrical, and signaling circuitry for communicating data over a communication link. To this end, communication interface(s) 210 may be configured to transmit and/or receive data using a variety of different communication protocols, such as TCP/IP, UDP, etc. Note that the device 200 may have multiple different types of communication interface(s) 210, e.g., wireless and wired/physical connections, and that the view herein is merely for illustration.

The memory 240 comprises a plurality of storage locations that are addressable by the processor(s) 220 and the communication interface(s) 210 for storing software programs and data structures associated with the embodiments described herein. The processor 220 may comprise necessary elements or logic adapted to execute the software programs and manipulate the data structures 245. An operating system 242, portions of which are typically resident in memory 240 and executed by the processor(s), functionally organizes the node by, inter alia, invoking network operations in support of software processors and/or services executing on the device. These software processors and/or services may comprise an identity federation and visibility process 248 and an open roaming registry process 249.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, is while processes may be shown and/or described separately, those skilled in the art will appreciate that processes may be routines or modules within other processes.

Modern supply chains typically span multiple organizations, such as the shipper of art item, any number of carriers, and the target destination of the item. As the item travels towards its destination, its digital representation may undergo a number of transformations. For instance, the identity of the item under the responsibility of a first carrier is likely to be different than the identity of the same item under the responsibility of a second carrier.

Even within a single organization, the identification of a particular item may vary due to the different technologies that shippers may employ. For instance, an item may be tagged using a barcode, a Quick Response (QR) code, radio frequency identification (RFID) tag, Bluetooth Low Energy (BLE) tag, cellular tag, or the like. It is also quite common for an item to be re-tagged when passing from one carrier to another (e.g., the new carrier puts a new barcode on the item being shipped). In doing so, this effectively changes the digital identity of the item. As a result, supply chains that span multiple organizations often lack end-to-end transparency.

Visibility represents one of the main areas of focus in supply chains, as they undergo a digital transformation. In general, visibility refers to the ability to answer questions such as the following:
What is this item?
Where is a particular item?
What is the state of a particular item?
Etc.
   Without visibility across the supply chain, it is quite difficult to make informed decisions. Despite this, modern supply chains tend to be fractured in terms of visibility, due to the myriad of organizations that may be involved.

A major challenge in automating end-to-end supply chains is that there is no one-size-fits-all identification technology that has received universal support by the industry. Today, for instance, some products may be tagged with radio frequency identification (RFID) transponders, others may use barcodes, Bluetooth Low Energy (BLE) or alternative technologies in the future, such as ultra-wideband (UWB) or cellular (e.g., 5G) active tags. These technologies have different identity spaces and formats, and many tagged products have different identity providers. For example, the identity of a product while under the responsibility of a first carrier is very likely to be different than the identity of the same product while under the responsibility of a second carrier. In fact, it is quite common for a product to be “re-tagged” when passing from one carrier to another, effectively changing its digital identity.

Even if all the supply chains worldwide would agree upon a single Universally Unique Identifier (UUID) and a common traceability technology, still dealing with different identity providers is unavoidable by the mere construction of the supply chain. For instance, many warehouses receive, store, and ship products manufactured by different entities, and therefore, those products will have different identity providers. In fact, supply chains are inherently federated ecosystems, but their members lack the ability to amalgamate the different identities and identity providers involved in this type of federation.

Accordingly, there is a real-world demand to verify, and attest to, the identity of items that are transported via a (contactless) supply chain across different organizations. One potential approach to achieving this would be to build complex integrations between the systems of two organizations a shipper and a carrier). However, this typically requires both organizations to use the same software or for one organization to ‘adapt’ to the system of another organization. Adaptation of a common system is typically not practical, when across an entire supply chain, as there may be many different organizations that have responsibility for an item.

### Item Identity Federation and Visibility as a Service

The techniques herein introduce an item identity federation and visibility service is that allows common policy lists to be rendered, automatically, for exchanging data between organizations based on their profiles (e.g., a manufacturer and a warehouse, a transporter and a warehouse, etc.). In some aspects, the techniques herein also allow users to select which information they wish to request from other organizations (e.g., a ‘visibility intent’), as well as the information they would like to publish to other organizations (e.g., a ‘visibility offering’). In further aspects, the techniques herein allow for the automatic matching of visibility policies among organizations: 1.) based on the identification technologies used (e.g., RFID, barcodes, BLE, etc.) and 2.) based on the specified visibility intents and the visibility offerings.

Operationally, the federated identity method introduced herein allow for information about an item to be shared across different organizations, systems, and/or technologies. In such a model, instead of a single identity system being used, requests for verification and/or validation of an identity may be passed to a specified identity provider. Note that prior approaches to this have mainly focused on the authentication and authorization of users or other data consumers. However, the requirements in terms of item identification in a contactless supply chain differ significantly from what these types of approaches offer. For instance, inventory visibility typically entails challenges relating to identification and notification across domains, rather than those relating to authentication or guest network access. Indeed, an RFID interrogator or barcode scanner will not need remote authentication of a passive RFID transponder or barcode, since such a functional requirement does not (currently) exist. Moreover, many of the devices used to tag (and identify) inventory do not need guest/Internet access (e.g., RFID, BLE, barcodes, UWB, etc.).

In addition, simplicity and ease of use is paramount in supply chains. Indeed, the to trend in this sector is to increase the level of automation of the large majority of the processes. In so doing, organizations are choosing to lease a significant part of the equipment and infrastructure needed to run the business, rather than purchase such systems themselves. This applies to a wide variety of equipment, ranging from advanced systems such as Automated Mobile Robots (AMRs) and automated forklifts to industrial is RFID interrogators, meaning that there is a rapidly increasing number of third-party identities and devices that need to interact with the local communications infrastructures and systems of an organization.

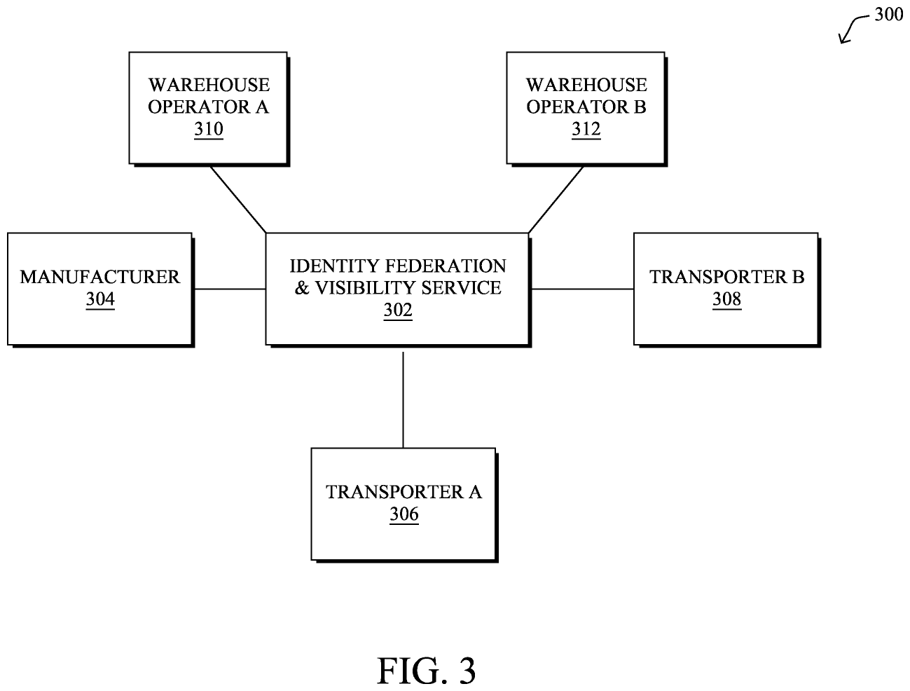

FIG. 3 illustrates an example identity federation and visibility service, according to various embodiments. As shown, system 300 may include an identity federation and visibility service 302 that allows any organization (e.g., a member of a supply chain) to easily initiate an identity federation. For instance, as shown, consider a typical supply chain that involves the following organizations: a manufacturer 304 that ships an item to a destination. During transit, any number of transporters, such as transporters 306-308 (e.g., a first transporter, a second transporter, etc.), may receive, transport, and hand off the item to another organization. In addition, there may be any number of other organizations involved in the supply chain, such as warehouse operators 310-312 (e.g., a first warehouse operator, a second warehouse operator, etc.), that store the shipped item while in transit and/or on delivery.

By way of example, consider the case in which manufacturer 304 is to send an item for delivery to a third-party warehouse operator 312 (e.g., a retailer). To do so, manufacturer 304 may pass the item to transporter 306. In turn, transporter 306 may ship the item and, at some point, deposit the item at a warehouse operated by warehouse operator 310. From there, transporter 308 may pick up the item from the first warehouse and convey it through its own channels until finally delivering the item to its final destination, a warehouse operated by warehouse operator 312.

At the core of system 300 is identity federation and visibility service 302, which may be provided by one or more devices, such as device 200, through the execution of identity federation and visibility process 248. In some instances, identity federation and visibility service 302 may be provided by an organization that differs from those of manufacturer 304, transporters 306-308, warehouse operators 310-312. In other instances, identity federation and visibility service 302 may be provided by any of these organizations.

After creating an identity federation via identity federation and visibility service 302, the creator can invite other organizations to join the federation and start using it. More specifically, the techniques herein allow even non-technically savvy users to create and/or join an identity federation via identity federation and visibility service 302 in a rapid manner. Once established, the identity federation provided by identity federation and visibility service 302 allows the authorized participant organizations to share and view information about the item throughout its traversal of the supply chain.

For instance, assume that each of the organizations 304-312 have registered with identity federation and visibility service 302 and participate in the identity federation of the item shipped by manufacturer 304. Each of these organizations may independently specify their intents in terms of what data they wish to receive regarding the item, as well as in terms of what data they are willing to share. Assume, for instance, that manufacturer 304 wishes to know the state of its item in terms of where it is, when it arrived at its current location, when it leaves, the level of inventory in its final destination, etc. Through the use of identity federation and visibility service 302, the other organizations 306-312 may provide updated information to identity federation and visibility service 302 regarding the item, automatically, allowing manufacturer 304 to access this information via identity federation and visibility service 302.

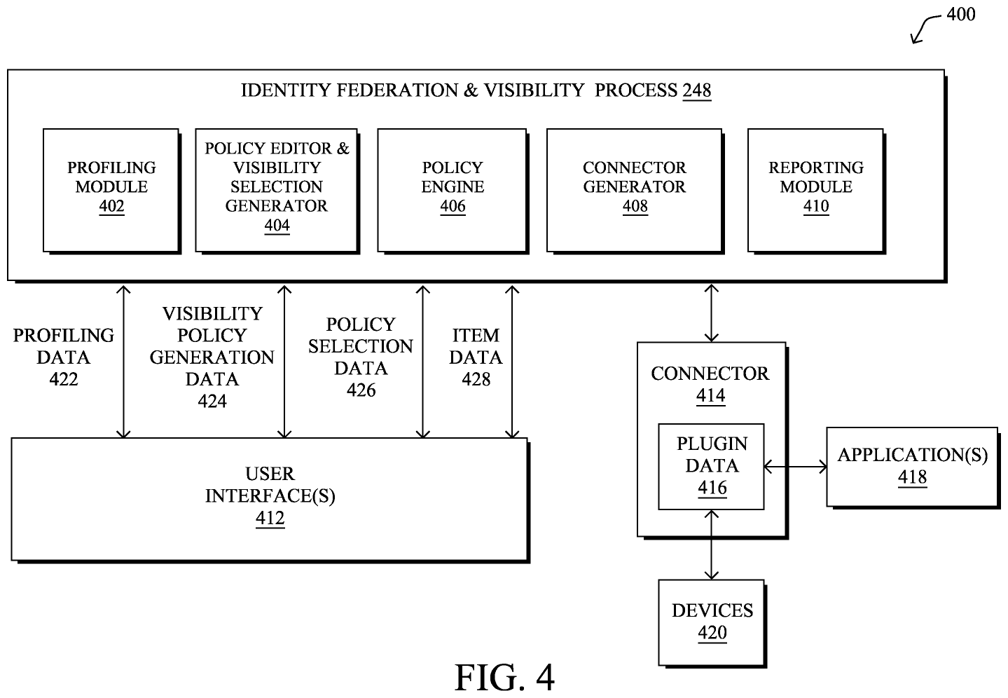

FIG. 4 illustrates an example architecture 400 for an identity federation and visibility service, such as identity federation and visibility service 302 in FIG. 3. At the core of architecture 400 is identity federation and visibility process 248 which may comprise any or all of the following components: a profiling module 402, a policy editor & visibility selection generator 404, a policy engine 406, a connector generator 408, and/or a reporting module 410. As would be appreciated, the functionalities of these components may be combined or omitted, as desired. In addition, these components may be implemented on a singular device or in a distributed manner, in which case the combination of executing devices can be viewed as their own singular device for purposes of executing identity federation and visibility process 248.

During execution, identity federation and visibility process 248 may communicate with any number of user interface(s) 412 operated by any number of people across any number of organizations. For instance, user interface(s) 412 may comprise desktop computers, laptop computers, smart phones, tablet devices, wearable electronic devices, or the like.

According to various embodiments, a domain expert for an organization may use user interface(s) 412 to specify profiling data 422 to identity federation and visibility process 248. In turn, profiling module 402 may use profiling data 422 to define a set of selectable visibility policies for the organization or a domain of the organization. In other words, profiling module 402 may generate and expose a set of pre-defined visibility offerings and intents that could be applied and/or modified later on by a particular organization. For instance, profiling data 422 may define different organization types, such as, but not limited to, manufacturers, warehouse operators, transporters, etc., in the case of a supply chain. In other embodiments, identity federation and visibility process 248 may be used to set up a federation in other use cases, as well, such as healthcare, insurance, or the like. As would be appreciated, the domain expert(s) may be unaffiliated with the specific organization participating in an identity federation and may simply provide a base set of defaults for process 248 for the usage domain (e.g., supply chain, healthcare, etc.).

The domain expert(s) may also provide visibility policy generation data 424 that allows policy editor & visibility selection generator 404 to automatically generate predefined policy templates. In general, visibility policy generation data 424 indicates the types of data that an organization with a particular profile may be able to share and/or the types of data that it may wish to be able to access. For instance, a policy template for a particular type of organization, as indicated by its profile, may specify a predefined set of preferences for its visibility intent and visibility offerings. In addition, the choices available for selection in the template may also depend on the organization type of the participant and/or those with whom the organization is to interact as part of the supply chain. For instance, a Manufacturer profile may be associated to a Manufacturer policy template, while a Warehouse might be associated to a Warehouse policy template. Based is on these two policy templates and considering the (Manufacturer, Warehouse) pair, policy editor & visibility selection generator 404 may auto-render a predefined set of choices that each member of the pair can select to express its visibility intent and offerings. Likewise, policy editor & visibility selection generator 404 may auto-render a predefined set of choices for a (Transporter, Warehouse) pair or a (Manufacturer, Transporter) pair. The list of auto-rendered policies may vary depending on the members profiles. For example, the visibility choices auto-rendered by policy editor & visibility selection generator 404 for (Manufacturer_1, Warehouse_1) and (Manufacturer_2, Warehouse_2) would be the same, while the one for (Transporter_1, Warehouse_1) might differ.

Thus, as a result of the processing by profiling module 402 and policy editor & selection generator 404, identity federation and visibility process 248 now has a set of default visibility policies that indicate the set of ‘intents’ of the organization or domain in terms of which data that it is able to share (e.g., its ‘visibility offerings’), as well as any information that it can access from another organization (e.g., its ‘visibility intent’).

Once the above initializations have occurred, specific organizations and their users may be onboarded by process 248. Such a registration may, for instance, associate a particular organization with a profile type and, accordingly, a set of default policy templates for them. For instance, a particular user at Warehouse A may provide details to process 248 regarding their organization (e.g., location information, contact information, etc.). In addition, this information may also indicate the specifics of the capabilities of the systems of the organization, such as its software systems, identification technologies in use, and/or any other information that may be captured regarding the participating organization. For instance, this information may indicate, for a particular organization or domain, which identification technologies are in use by that organization, such as RFID tags, barcodes, Wi-Fi, cellular, BLE tags, UWB, and the like.

In various embodiments, a user associated with a particular organization registered with process 248 may specify policy selection data 426, which is used by connector generator 408 to construct and deploy the appropriate connector(s) 414, to is facilitate the corresponding sharing of data across organizations. Typically, policy selection data 426 comprises a selection of the visibility intent and/or visibility offering of that user. For instance, policy selection data 426 may take the form of checkbox input that allows a user to select from among the template policy options generated previously by policy editor & visibility selection generator 404 and based on the specific profiles of the organizations involved.

Regarding visibility selection, the identity federation and visibility service may provide display data to a user interface associated with a 3^{rd} party warehouse (e.g., Warehouse W), thereby allowing a user of that organization to specify policy selection data 426 for a Manufacturer M (e.g., manufacturer 304). For instance, display data may take the form of a user interface (e.g., graphical user interface-based) checklist via which the user is able to specify the policy target(s), send policy data regarding what types of information should be sent, as well as the corresponding receive policy data. Similarly, other display data may be sent to a user interface associated with Manufacturer M, also a participant in the identity federation, that allows that organization to specify its own policy target(s), send policy data, and receive policy data, with respect to Warehouse W.

As would be appreciated, the options available to a user may vary depending on the organization type, the peer's organization type, identification technology, etc., and selectable pairs may be auto-rendered based on profile pairs (e.g., a manufacturer-warehouse pair, a warehouse-carrier pair, etc.). For instance, a warehouse operator may specify any or all of the following as part of a send policy: notify arrival, notify departure, in stock query, quantity in stock query and specify any or all of the following as part of a receive policy: estimated time of departure (ETD) updates, asset description, or asset state. In contrast, a manufacturer may be able to specify any or all of the following as part of a send policy: ETD updates, asset description, or asset state. In addition, the manufacturer may specify any or all of the following as part of a receive policy: notify arrival, notify departure, in stock query, quantity in stock query. Another example selection may indicate the location of a particular item (e.g., in terms of coordinates), which may be of interest with respect to a transporter.

According to various embodiments, policy engine 406 may match visibility intents and visibility offerings specified via policy selection data 426 across any number of organizations or domains. For instance, one organization may wish to receive a notification when another organization receives any of its shipped goods. If the second organization specifies a visibility offering that matches the visibility intent of the first organization, policy engine 406 may implement the corresponding data sharing policy between the two organizations. In other words, the role of policy engine 406 may be to: 1.) hook, map, and manage the send and receive policies produced by policy editor & visibility selection generator 404, 2.) perform matching among those send and receive policies selected via policy selection data 426, and/or 3.) distribute the policies to the identity federation core and to the applicable connectors, such as connector 414, as detailed below.

As would be appreciated, the set of available options for an organization, as well as its selected visibility offerings and intents, can change over time. Indeed, even though a default set of selectable options may be configured for an organization, these options can be modified over time, as needed, in some embodiments. For instance, say an organization outfits its warehouse with BLE scanners. In such a case, a person associated with that organization may specify this new offering as an option to identity federation and visibility process 248. In turn, the new options will be auto-rendered and made available to the users of the federation. Similarly, a user may adjust their policy selection data 426 over time, such as when additional information is desired, certain information is no longer of interest, etc. Indeed, even though process 248 may present users with default options to set visibility policies, these options could be modified over time. For instance, in some embodiments, this could be instrumented either via a new configuration by an authorized user or programmatically (e.g., through 424), including the introduction of new visibility policies and data models.

Identity federation and visibility process 248 may also maintain any number of identity federations across open, semi-private, or private consortia of the various is organizations. In addition, members may be part of multiple identity federations maintained by identity federation and visibility process 248, simultaneously.

In some embodiments, an identity federation may be implemented as an unmanaged service, through the execution of identity federation and visibility process 248, with no requirement for an identity federation provider to operate the federation. This allows the federation to begin functioning as soon as a first organization establishes it and invites a second organization to participate in the federation and start exchanging data.

In the case in which a user opts to start a new identity federation, the user may specify this to process 248, such as the name of the new identity federation, invitees to the federation, and the like. In one embodiment, identity federation and visibility process 248 may also suggest invitees to the user via user interface 412 and/or allow the user to pick invitees from a predefined list. This may be based, for instance, on the prior selections of the user and/or organization for other identity federations, the most common invitees (e.g., particular transporters, etc.), a template defined by the user, or the like.

As would be appreciated, not all of the invitees specified by a user may be registered with identity federation and visibility process 248. In such cases, the user setting up a new federation may also specify information such as any or all of the following:
1. The name of the invitee (e.g., ‘Warehouse W1’).
2. An email address or other contact information to which identity federation and visibility process 248 may send an invitation for the identity federation.
3. A member role that indicates the allowed activities for the invitee within the federation (e.g., “member,” “co-owner,” “member with the right to invite others,” etc.).
4. Membership duration information (e.g., one day, one week, permanent, etc.).
5. Other information regarding the invitee (e.g., the location of the invitee, notes, etc.).

Note that, in some instances, the creator of an identity federation via identity federation and visibility process 248 may also delegate the ability to invite others to one or more invitees. This is an important capability, as many logistics and transportation companies rely on several layers of subcontracting in order to deliver an outcome. By extending invitations to subcontractors so that they can participate in the identity federation and exchange information about an item, visibility of the item can be greatly improved. Once the process is complete, identity federation and visibility process 248 may send invitations to the selected invitees (e.g., by sending links to identity federation and visibility process 248 by email, text message, etc.).

In general, an invitation to join an identity federation may identify the federation to the invitee and may include security token information that identifies the invitee to identity federation and visibility process 248. Once registered with identity federation and visibility process 248, or logged into an existing account, the invitee may enroll with the created identity federation. During this step, each party may select whether its profile should be public or not (e.g., whether the company/entity name should be publicly available and listed). An organization may also maintain different accounts and/or user roles, such as when the organization participates in different identity federations. For instance, a member may create internal tenant accounts, such as a ‘viewer’ account, an ‘admin’ account, etc.

According to various embodiments, connector generator 408 of identity federation and visibility process 248 may be configured to generate any number of ‘connectors’ for the participants in a federation, based on matches between their visibility offerings and visibility intents. For instance, connector generator 408 may generate connector 414 that encompasses the software necessary to interface with the item identification technologies used by a particular organization/participant in an identity federation.

As would be appreciated, item information may depend heavily on the internal systems of the source organization. For instance, different organizations may maintain is item information in various enterprise-level applications or systems, such as an Enterprise Resource Planning (ERP) system, a Warehouse Management System (WMS), a Warehouse Execution System (WES), a Transport Management System (TMS), or the like. To this end, connector generator 408 may be configured to select plugin data 416 for inclusion in a connector (e.g., connector 414) that facilitates the sharing of information from that resource. For instance, assume that an organization uses one or more application(s) 418 to maintain item information, such as a TMS. In such a case, plugin data 416 may include the information needed to interface with the TMS of the organization (e.g., credential information, etc.), to obtain or update information about an item in transport by the organization. Similarly, a connector 414 may be configured to share data from particular device(s) 420, such as an RFID reader, etc., via the federation.

Typically, the communications enabled by plugin data 416 may be limited to accessing only the information needed to support the visibility intents and visibility offerings associated with the various participants, as determined and enforced by policy engine 406. For example, assume that Warehouse W1 receives a pallet of RFID-tagged items from Manufacturer M. As soon as an RFID reader of Warehouse W1 scan the items, the corresponding information may be captured into the application(s) 418 of Warehouse W1 and captured by way of plugin data 416, which may comprise one or more plugins for those application(s) 418. In reading the information encoded on the RFID tag, the system is able to determine the identity provider as being Manufacturer M. This then determines that the information should be ‘routed’ according to the policy associated with Manufacturer M. Note that this data flow may occur because Manufacturer M specified a visibility intent of “notify arrival” that matched a visibility offering selected by Warehouse W1.

In further embodiments, connector 414 may include plugin data 416 configured to interface with the device(s) 420 of the organization, directly. For example, connector 414 may receive data in parallel from any number of deployed RFID scanners in addition to, or in lieu of, interfacing with a WMS or other application 418 of that organization. For instance, connector 414 may obtain scan information directly from a scanner, but may is obtain inventory count information from a WMS or other application 418.

According to various embodiments, connector generator 408 may construct a connector 414 based on the profile of the organization, its identification technologies, and/or its corresponding plugins. In general, connector 414 functions as an entity that allows an organization to connect to identity federation and visibility process 248 and exchange data flows. For security reasons, connector 414 may also include a certificate signed by connector generator 408, to certify its identity to the identity federation and visibility process 248. Likewise, the identity federation and visibility process 248 may also handle a certificate to certify its identity to the organization's connector 414.

Assume, for instance, that a participant in an identity federation has specified the following: Profile=“Warehouse”; Technologies=“(RFID, Barcodes)”; Plugin=“Oracle's WMS version X”; CERT=“W_autosigned”. In this example, connector 414 may take the form of a software element (e.g., an image), which, once instantiated, embeds the processes providing the following functionality:
A list of policies that the participant can select to define its visibility intent, based on its profile, which may be modifiable on a per-participant basis.
A list of policies that the participant can select to define its visibility offering, based on its profile, which may also be modifiable on a per-participant basis.
The ability to parse and forward Electronic Product Codes (EPCs) from application(s) 418 and/or device 420, which is the standardized identity format used both by RFID tags and Barcodes.
Plugin data 416 to parse and forward a set of messages to/from Oracle's WMS (e.g., an application 418).
Code to create secure communications with identity federation and visibility process 248 that are authenticated using the certificate information provided by connector generator 408.

In some embodiments, a new connector 414 may be instantiated for each identity federation in which an organization participates. In another embodiment, a single is connector 414 may include the ability to slice and isolate item data from different identity federations, as in the case in which the organization is participating in multiple identity federations. In further embodiments, connector 414 may also be configured to store and cache policies (e.g., by implementing a localized form of policy engine 406).

Once connector generator 408 has generated a connector 414, identity federation and visibility process 248 may deploy it to its target organization either on a push basis or on a pull basis (e.g., in response to the organization requesting a download of connector 414). As noted, the specific configuration of connector 414 may depend on the identification technologies and/or plugins specified by the target organization. For instance, if RFID and barcodes were chosen, connector 414 may be configured as yet another data consumer in the existing data capture workflows of the organization, as well as interface with internal application(s) 418. In a further enhancement, connector 414 may also interface directly with the endpoint devices and/or networking equipment responsible for capturing and reporting the item data. For instance, connector 414 may be configured to interface with BLE beacons, UWB anchors, Layer 2 switches, wireless access points, wireless access point controllers, or the like. To support this, connector generator 408 may include the corresponding plugin data 416 into connector 414, such as the plugin data needed to interface with application programming interfaces (APIs) of a network switch, barcode reader, etc.

Once connector 414 has been deployed, it may automatically and securely connect to identity federation and visibility process 248 (e.g., the service) and/or directly with other connectors of other participating organizations in the federation. This may be achieved by establishing a mutual transport layer security (mTLS) tunnel, for instance. Thus, as shown previously in FIG. 3, identity federation and visibility service 302 may communicate with organizations 304-312 via secure tunnels that are established with corresponding connectors 414 deployed to those organizations. In turn, the connectors may report the required item data to service 302, as needed.

Policy engine 406 is also responsible for enforcing the visibility policies generated by policy editor & visibility selection generator 404. As would be appreciated, the visibility policies between organizations may differ. Indeed, the policies for exchanging data between a transporter and a warehouse operator may differ from the policies for exchanging data between a manufacturer and a warehouse operator, Thus, a warehouse operator may share certain information with a carrier that the shipper (e.g., the manufacturer) may not be allowed to view.

Policy enforcement by policy engine 406 can be achieved by placing restrictions on reporting module 410, which is responsible for reporting any item data collected by a connector 414 to any of the other participants of the federation that match that data. In turn, reporting module 410 may provide that collected item data as item data 428 to the authorized organizations via user interface(s) 412. Note that the functionalities of reporting module 410 may also be implemented as part of connector 414, thereby allowing connector 414 to report item data 428 to one or more other connectors, directly, for presentation to a user interface 412. In various embodiments, item data 428 may be sent via the corresponding connector(s) 414 deployed to the destination organization(s) authorized to receive the item data. This allows, in some instances, item data 428 to be fed into the system(s) of that organization via the plugin data of the connector. For instance, in some cases, item data 428 may automatically populate the ERP system of the organization receiving item data 428.

By way of illustration of the operation of the full system, consider again the case shown in FIG. 3. Assume that manufacturer 304 ships an item with a passive RFID tag to warehouse operator 310. An RFID reader in the warehouse may read the data in the RFID tag, providing local visibility to the systems of warehouse operator 310 (e.g., a WMS application, etc.). The item data read by the RFID interrogator thus reaches the connector deployed to warehouse operator 310, allowing the connector to either find a matching entry or filter the data. Various embodiments could be used to enable such functionality at the connector level. For example, connectors might cache the ID of the owners (or identity providers) along with the corresponding visibility policy. Another option could be to push policy and updates to the connectors. The connectors might also is be stateless and might not be endowed with any caching mechanism, in which case, the messages will always hit the federation.

In more complex examples, visibility policies may allow for different levels of aggregation, such as by aggregating groups of item identifiers. For instance, a ‘notify arrival’ policy may be applied to an entire pallet of items, rather than for each of the individual items on the pallet.

In some embodiments, the identity federation may be used for exchanging both identity-related data, as well as context and state-related data, subject to the visibility policies described above. In other words, identity federation and visibility service 302 may serve as both the control plane and data plane, to enable the desired levels of visibility among parties in the supply chain. In other embodiments, the identity federation may only carry control plane data and may provide trusted pointers (e.g., endpoint addresses), so that the parties can exchange context and state-related data directly among themselves. In a further enhancement, the identity federation may support a hybrid model, providing both control and data plane functions for certain types of identities, profile members or visibility functions, while providing control «data plane separation for others.

In further enhancements, the identity federation may support any or all of the following:
more flexible profiles and templates, such as customizable templates;
programmable/extensible policies;
programmable/extensible plugins;
more flexible certificate and handling or even a full-fledged public key infrastructure (PKI); or
additional decoupling between the identifying/routing functions and the exchange of context and state-related data.

According to various embodiments, the federation techniques herein can also be extended to exchange information regarding connected assets and/or the workforce of the organizations. For instance, assume that warehouse operator 310 has deployed a number of AMRs or automated forklifts in its warehouse. In such cases, the connector deployed to warehouse operator 310 may also interface with their corresponding systems, to provide the manufacturer of those devices (and any other authorized participant of the federation) information regarding these devices. Similarly, personnel information could also be captured and sent, through the use of the appropriate connector and plugins. For instance, warehouse operator 310 may send to transporter 308 information regarding the precise location of the item, identification of the robot or person transporting the item within the warehouse, and an expected time that the item will be ready for pickup by transporter 308.

Warehouse operators are increasingly leasing high-value equipment, such as AMRs and the like. Since such systems require data network communication in order to operate, AMRs or unmanned forklifts represent third-party devices that require trusted access to the warehouse network. Thus, identity federation and visibility service 302 may be used to dynamically identify these assets and enable trustworthy communications between these assets and the management systems of their corresponding service providers, which may be integrated into the federation as additional participants.

For instance, warehouse operator 310 may exchange data gathered through a Wi-Fi technology connector with remote Forklift or Robotics Management systems running in a remote location, such as a cloud-hosted compute facility. However, it, may exchange data gathered only through the MD connector with other parties upstream in the supply chain, including the manufacturer/seller of the items tagged with RFID.

In a given supply chain, tracking of shipments and inventory has conventionally been focused on proprietary solutions based on singular beacon/tag technologies, for example, BLE or RFID. These technologies oftentimes do not support roaming across different domains, as opposed to long range (LoRa) or cellular networks that do. In other words, different domains/organizations that are part of a supply chain are forced to adopt a same solution (e.g., a particular tracking technology) to identify beacons/tags as they transit across the supply chain's chain of custody and to share relevant information (to upstream and downstream domains). In practice, however, a particular domain (e.g., carriers, warehouses, manufacturers, etc.) of a supply chain may handle shipments, goods, etc. that are “tracked” with a particular beacon/tag technology that is non-interoperable and disparate from the point-of-view of the particular domain (e.g., the goods are based on solutions using proprietary identifier allocations for a real-time location systems). In an example, one domain of a supply chain may implement BLE-based iBeacon identifiers (e.g., with UUID/major/minor fields) managed by a particular solution provider. That particular solution implemented by that domain may be incompatible with another domain, in the same supply chain, that uses a solution by another solution provider implementing a different technology (e.g., Eddystone, AltBeacon, etc.). Even in the case where the other domain may use BLE-based iBeacon identifiers (i.e., the two domains share a technology type), the two solution providers may assign identifiers in an uncoordinated manner that renders the identifiers non-interoperable and may potentially lead to identifier collisions (e.g., the UUID/major/minor fields are implemented differently, have different semantics, overlap, conflict).

To provide roaming capabilities across different networks and solution providers using the above-described beacon/tag technologies (e.g., BLE beacons, RFID tags, etc.), a variety of challenges are presented, in part, because these technologies do not natively support roaming. In particular, some of these challenges include:
the absence of an authority and/or service that enables allocation of addresses in a collision free and fair manner across organizations;
the lack of interoperability between the identifiers assigned and used by different solution providers; and
the lack of a given solution provider's capacity to identify, on-the-fly, another solution provider's identity provider (IDP) (e.g., from an identifier) and to securely forward relevant information to the other solution provider (or upstream/downstream members of a same supply chain). As an example, a third-party warehouse may want to be able to identify a shipper (e.g., an IDP) of a tagged pallet or parcel and to notify the shipper that the pallet or parcel has arrived to or departed from the warehouse, without depending on a common solution provider.

### Cross-Organization Tracking Identifier Space Allocation for Supply Chains

The features provided by the example identity federation and visibility service (for supply chain partners), according to various embodiments described above, enables previously siloed systems of a supply chain to share information with one another. The techniques herein further introduce an open roaming registry process 249 to provide for cross-organization tracking identifier space allocation for supply chains. In other words, the techniques herein enable the tracking of assets, goods, shipments, inventory, etc. across different organizations without depending on a single, oftentimes proprietary, tracking technology that is deployed end-to-end in a supply chain.

By analyzing the federation and monitoring of an entire supply chain among conventionally separated organizations, the techniques herein enable automation of allocation of collision-free address spaces (e.g., tracking identifiers), while guaranteeing fair use of the identifier address space by various organizations of a given supply chain. Particularly, identifier space allocation maybe performed and applicable for a variety of tracking technologies used in supply chains that lack native roaming support, for example, BLE beacons/tags, RFID tags, various PAN identifiers, non-RF technologies (QR codes or barcodes), etc. It is contemplated that beyond supply chains, the identifier space allocation may be deployed in environments where non-roaming, potentially proprietary, asset/inventory tracking technologies are used (e.g., healthcare environments).

Notably, the techniques herein enable tracking technologies that were not initially designed to support roaming to be used in elements such as tags, beacons, in a manner such that the elements may be identified and openly roam across different access or is scanning networks of solution providers (or domains of a supply chain). These access or scanning networks may support or be part of a particular domain's network infrastructure, which in turn may be a member of an “open” roaming federation (e.g., an identity federation and visibility system/service a described above herein). More specifically, the techniques here introduce features that include:
automated and dynamic requesting, allocating, and registering of address spaces for tracking identifiers in a collision-free and fair manner across organizations (where the requests may be made by members of a federation in an uncoordinated manner, handled concurrently, and granted automatically in real time by a federation);
structuring of tracking identifier address spaces in a manner that ensures interoperability of the identifiers assigned across different solution providers; and
enabling access or scanning network to identify on-the-fly an IDP of a “visiting” beacon, tag, label, or code attached to a roaming object (e.g., a pallet, a parcel, etc.) to securely forward relevant information/data to a corresponding IDP or other members of an open roaming federation (where both the access or scanning network and the IDP may be members of the open roaming federation).

Illustratively, the techniques described herein may be performed by hardware, software, and/or firmware, such as in accordance with the open roaming registry process 249 (in combination with identity federation and visibility process 248), which may include computer executable instructions executed by the processor 220 (or independent processor of interfaces 210) to perform functions relating to the techniques described herein.

Specifically, according to various embodiments, a device receives, from a client at a first organization, a tracking identifier space allocation request for one or more physical assets. The device identifies, based on the tracking identifier space allocation request, a range of tracking identifiers that are not allocated to one or more other organizations for use. The device sends, to the client at the first organization, a tracking identifier space is allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations.

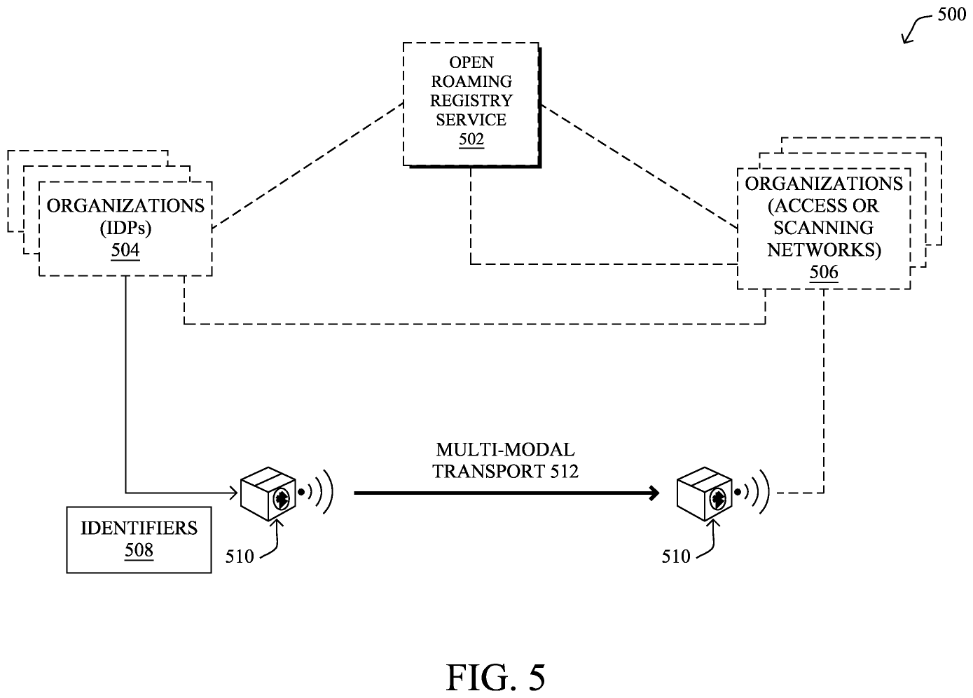

Turning now to FIG. 5, illustrates an example architecture 500 for an open roaming registry service 502 (that implements the open roaming registry process 249). In particular, as shown, open roaming registry service 502 may be in communication with one or more organizations 504 that are identity providers (IDPs) and other (upstream or downstream) organizations 506. One or more organizations 504 may communicate with open roaming registry service 502, for example, over an application programming interface (API) that receives and processes requests for tracking identifier (e.g., address) space allocations from different organizations (e.g., one or more organizations 504). These requests may be understood as tracking identifier space allocation requests.

Open roaming registry service 502 may support these requests concurrently, without requiring coordination or consensus among one or more organizations 504. Further, open roaming registry service 502 may manage the requests dynamically and, as will be described in greater detail herein below, may automatically allocate and register address ranges in a collision-free and fair manner. After processing the requests, open roaming registry service 502 may respond to requesting organizations with indications as to whether the address space allocations have been assigned or denied. One or more organizations 504 may be configured to use the address space assigned by open roaming registry service 502 to configure identifier(s) 508 for one or more assets 510. For example, identifier(s) 508 of a BLE beacon, an RFID tag, a scannable label, a barcode, a QR code, etc. may affixed to an object (e.g., a pallet, a parcel, a package, etc.) that is to be shipped across a supply chain to organizations 506, for example, over multi-modal transport 512 (e.g., ship, freight, air, etc.).

Organizations 506, in the capacity as access or scanning networks, may receive is one or more assets 510 (that have identifier(s) 508 affixed). It is to be understood that an organization may be configured as both as an IDP and as an access or scanning network. Further, open roaming registry service 502 and organizations 506 may comprise a seaport terminal, an airport, a transport vehicle, a warehouse, or a distribution center where one or more connectors are deployed, as described herein. Organizations 506 may be configured to recognize and read identifier(s) 508, for example, using the connectors. More specifically, the organizations 506 may not only identify a type of technology associated with identifier(s) 508 but also an identity of one or more organizations 504. For example, a BLE beacon/tag may be attached to an object in transit, which may be programmed in advertising mode. Such tag may periodically advertise BLE beacons (e.g., iBeacons), which might be received by organizations 506 (e.g., using an access point of an access or scanning network). That is, organizations 506 may now identify identifier(s) 508 and “act” accordingly, irrespective of a particular solution provider implemented by one or more organizations 504. It is contemplated that “acts” taken by organizations 506 may include: triggering a workflow to handle an asset in an unmanned manner, notifying operators that the object has arrived, notifying an upstream or downstream organization about the arrival of the asset, etc. Organizations 506 may also be configured to transmit information to open roaming registry service 502, which as will be described herein may be used for analyses by open roaming registry service 502.

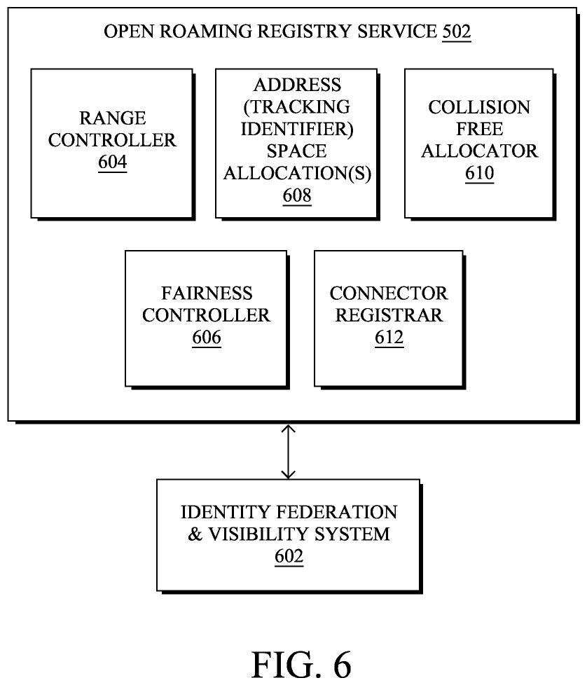

FIG. 6 illustrates components of an example open roaming registry service 502 for an identity federation and visibility service. In particular, open roaming registry service 502 may be in communication with identity federation and visibility system/service 602, where identity federation and visibility system/service 602 includes one or more supply chains that have identity federation and visibility process 248 implemented according to techniques described herein above. Open roaming registry service 502 may comprise range controller 604, fairness controller 606, address (tracking identifier) space allocation(s) 608, collision free allocator 610, and connector registrar 612.

As will be described in greater detail herein below, range controller 604 may be is configured to queue and process tracking identifier space allocation requests concurrently. Range controller 604, by parsing range sizes of the requests, may determine whether there is sufficient space available enabling the allocation request. Generally, fairness controller 606 is configured to log and monitor utilization of the address ranges assigned to a particular requestor, for example, in space allocation(s) 608. Collision free allocator 610 may be configured to select one or more tracking identifier ranges to be assigned based on, for example, requested range sizes and/or policies by one or more organizations/domains. Connector registrar 612 may be configured to retrieve information regarding a connector of an organization (e.g., an IDP) and to bind identifier information to particular address ranges.

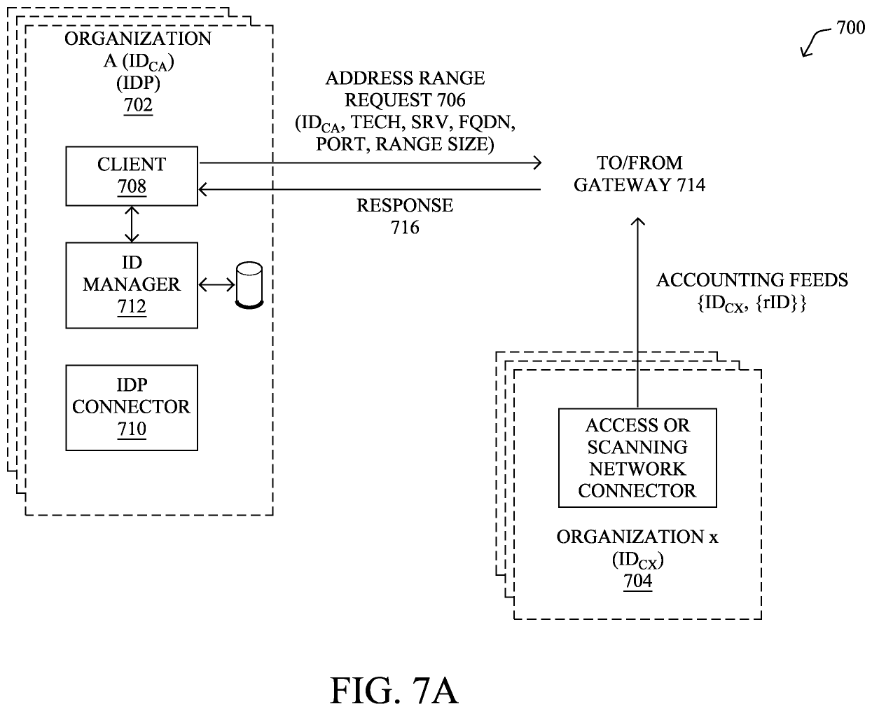

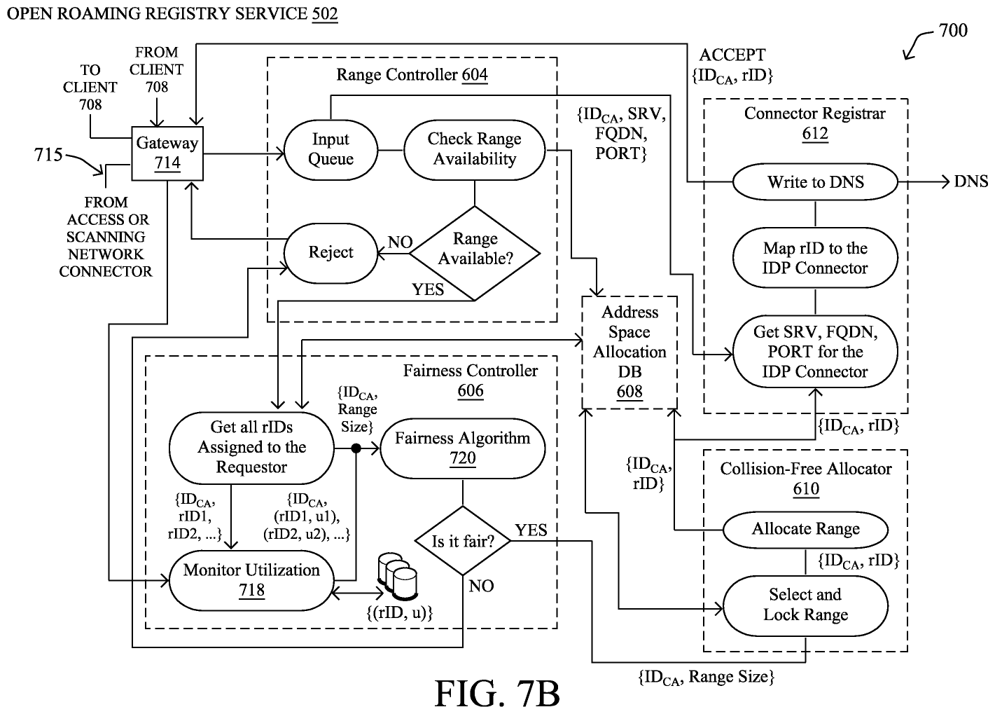

FIGS. 7A-7B illustrate an example system 700 that includes an open roaming registry service 502. As shown in FIG. 7A, open roaming registry service 502 may be in communication with a first organization 702 of a supply chain and a second organization 704 of the supply chain. First organization 702 may be configured to send an address (tracking identifier) range request 706 to open roaming registry service 502, for example, for a particular set of assets (that are to be tracked and monitored). As shown, the request may be sent by an open roaming registry service client 708 associated with first organization 702. Further, the range request 706 may include:
a unique identifier (e.g., ID_{CA}) assigned to first organization 702 by open roaming registry service 502, for example, during onboarding or at an enrollment process of first organization 702 to open roaming registry service 502 (it is contemplated that, during the request, first organization 702 may use its ID and credentials to authenticate itself with open roaming registry service 502);
a technology type indicator that indicates a tracking technology and type of identifier for which the request applies (e.g., this input may indicate various tracking technologies such as BLE iBeacon, BLE Eddystone, BLE AltBeacon, RAIN RFID Alliance compliant ID type, scannable labels like a standardized category of barcode IDs, QR code embedding, etc.);
first organization 702 connector information which may include, for example, a tuple that comprises elements such as a specific service (SRV), a fully qualified domain name (FQDN), and a port that may be used to identify a connector 710 associated to first organization 702 within an open roaming federation, such as the one shown in FIG. 3 that may be used to implement both open and closed identity federations (it is contemplated that the tuple may be dynamically discovered by second organization 704 based on the information encoded in the ID attached or tagged to a particular asset); and
a range size that indicates a size of address (tracking space) space requested (it is contemplated that, in some embodiments, first organization 702 may request or suggest address ranges that were previously used by them before enrolling with open roaming registry service 502, which may be stored in a identifier manager 712 of first organization 702).

A gateway 714 of open roaming registry service 502 may be configured to process and dispatch concurrent requests (e.g., from first organization 702), accounting feeds coming from the access or scanning networks (e.g., from second organization 704), and the responses sent to the requesting organizations. In particular, gateway 714 may, after receiving range request 706, dispatch it to range controller 604. As shown, range controller 604 may parse the range size requested then determine whether there is sufficient space available enabling the allocation request, for example, within space allocation(s) 608. Such availability may entail possible allocations in the form of a single addressing block or various non-contiguous space allocations in order to fill the request. If there is sufficient space available, range request 706 may then be dispatched/forwarded to fairness controller 606. Otherwise, it may be rejected, and a response 716 may be sent back to first organization 702 (indicating that the request has been rejected)

Fairness controller 606 as shown in FIG. 7B, upon receiving range request 706, may retrieve all the address ranges already allocated to first organization 702 (“{rID1, rID2, . . . }”), for example, from space allocation(s) 608 (based on the unique identifier in range request 706, as described above). First organization 702 may have been allocated is multiple address ranges (“rID(s)”) within space allocation(s) 608. For example, first organization 702 may have been granted address spaces previously or contiguous address space allocations were not feasible. A monitor utilization module 718 of fairness controller 606 may retrieve accounting information for each address range detected by the connectors associated to second organization 704. In a specific example, an access point may receive BLE beaconing messages from roaming sensors in its area of coverage at a domain of a supply chain, which might be available to an access or scanning network connector (via MQTT or other mechanisms) to get information from the access point. Control plane data obtained from the beaconing messages (e.g., an identity range associated to the IDP) might be enriched with additional metadata or information (e.g., an identifier of second organization 704) and sent as accounting feeds to the open roaming registry service 502. Metadata, as part of for example, accounting and/or data feeds 715, may be sent from second organization 704 through gateway 714 to monitor utilization module 718, which allows fairness controller 606 to log and monitor utilization (u) of address ranges, rID(s), assigned to the first organization 702.

It is contemplated that such (constant) monitoring and closed-loop control may serve as an input to a fairness algorithm/process 720 of fairness controller 606. Fairness algorithm/process 720 may analyze not only the utilization (u) associated to each range rID but also the effective use of all the address ranges allocated to a requestor, for example, first organization 702. A fairness function may be part of the fairness algorithm/process 720, that decide (e.g., based on a multi-objective fairness score) whether range request 706 is fair. In the case where the fairness function determines that it is not fair, range request 706 may be rejected and the requestor may be notified.

In the case where the fairness function determines that it is fair, range request 706 may be obtained by collision free allocator 610, which may select one or more ranges, rID(s), to be assigned. Collision free allocator 610 may make this selection based on a range size requested by the IDP (e.g., first organization 702) and one or more internal policies (e.g., managed by open roaming registry service 502). To avoid collisions, a lock-based system supporting eventual rollbacks may be implemented. That is, collision is free allocator 610 and connector registrar 612 may be configured to perform “atomic” operations so as to ensure data consistency. Collision free allocator 610 may select one or more address ranges, rID(s), bind the ranges chosen to an identifier of first organization 702 (e.g., ID_{CA})), and store a binding of the address ranges to the identifier of first organization 702 thereby capturing the address space allocation (e.g., using a distributed and replicated database).

Connector registrar 612 may also obtain the binding of the address ranges to the identifier of first organization 702. Additionally, connector registrar 612 may retrieve the details of connector 710 (e.g., tuple (SRV, FQDN, PORT)) from a queue of range controller 604, then bind the details to range selected (e.g., by collision free allocator 610). Such binding may be made publicly available by creating a new entry in a domain name system (DNS) configured to resolve bindings of open roaming registry service 502, which shall be described with greater detail herein below. Connector registrar 612 may be further configured to flush the range request 706 from the queue of range controller 604 then respond with response 716 (indicating the new allocation to the first organization 702). Upon receiving response 716, open roaming registry service client 708 may forward the new address space allocation to an identity management tool, such as identifier manager 712.

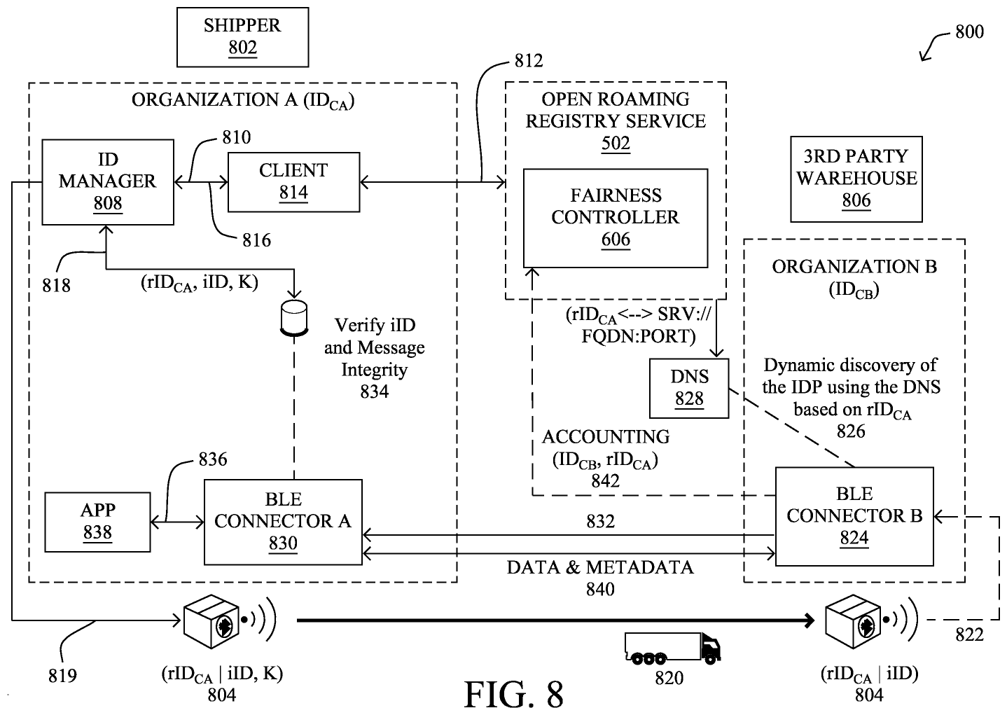

Turning now to FIG. 8, an example flow diagram 800 for an open roaming registry service 502 (in a supply chain and logistics context) is shown. In particular, a shipper 802 that may be sending one or more assets 804 to a third-party warehouse 806. Shipper 802 may desire attaching a BLE beacon to one or more assets 804 for tracking purposes; particular, shipper 802 may have a goal of receiving a notification from third-party warehouse 806 once one or more assets 804 arrive. By leveraging open roaming registry service 502, the request, allocation, and measurement of utilization of address spaces may be enabled in various supply chains. Further, it is contemplated that identity federation and visibility system/service 602, as described herein, may allow shipper 802 and third party warehouse 806 to exchange information associated with one or more assets 804 (e.g., location data in near real-time, data facilitating its handling by an is operations team within the warehouse, etc.).

An identity management tool 808 of shipper 802 may manage one or more identifiers assigned to the sensors used to track one or more assets 804. At step 810, identity management tool 808 may be configured to determine that a tracking identifier system of shipper 802 is running out of tracking identifier addresses that could be assigned to BLE iBeacon tags, and therefore, needs more addressing space. At step 812, identity management tool 808 may be configured use an open roaming service client 814 to issue a new tracking identifier address space allocation request to open roaming registry service 502 (as described herein above). In cases where the request is granted, at step 816, open roaming service client 814 may forward the tracking identifier address range assigned to identity management tool 808.

Identity management tool 808 may handle the assigned range(s) (e.g., rID(s)) received from open roaming registry service 502 and may generate new item identifiers (“iIDs”) within the range(s) allocated. In some embodiments, identity management tool 808 may, at step 818, also compute and associate a key, K, for each individual item identifier and store an associated tuple (e.g., “rID, iID, K”), for example, in a database. Such keys may be used to ensure the integrity of iBeacon messages as they transit across different networks. It is contemplated that other embodiments may not require a pre-computed (stored) key.

Whenever a new asset needs to be shipped and tracked, identity management tool 808 may be instructed to configure a corresponding BLE beacon. It is contemplated that identity management tool 808 may be configured to, alternatively, be consulted by an automated process that performs a similar function. Such process may configure the UUID as well as major and minor fields (of a payload) to be used in iBeacons. Further, the process may upload the key, K, or even update the BLE beacon firmware (e.g., so that a BLE device uses the key K to add an integrity code within a standard iBeacon frame). In order to enable third-party warehouse 806 to have the ability to identify shipper 802 based on the ID encoded in a BLE iBeacon, the user-programmable fields UUID as well as major and minor fields may be split and assigned as follows by open roaming registry is service 502:
a prefix or preamble to indicate that the BLE device carries an open roaming compliant identifier (in some embodiments, the preamble may be encoded with an identifier of a federation, for example, when a device may be reprogrammed to roam across different federations);
a range ID (e.g., rID) allocated by open roaming registry service 502 to identify shipper 802;
an Item ID (e.g., iID) generated by shipper 802 that identifies a specific item while it roams across different organizations (e.g., from shipper 802 to third-party warehouse 806);
a nonce that is a sequence number or any alternative logic to introduce a variable field in a header in case an integrity code is used; and
a suffix carrying an integrity code, for example, computed by hashing the prefix, the rID, the iID, and the nonce with a key K (in some embodiments, particular devices might require firmware updates to either accept or to dynamically derive a key K and compute the integrity code in the above-described fields for the purpose of decoding collision-free identifiers and verifying integrity of key fields in the headers carrying such identifiers).

Such user-programmable fields UUID as well as major and minor fields are described with reference to uses with BLE iBeaconing, which comprises an addressable space totaling 20 bytes (that provides sufficient room to for open roaming registry service 502 for managing encoding of the above listed fields in a collision free and fair manner across the requesting organizations). It is contemplated that similar principles may apply to BLE Eddystone, BLE AltBeacon, a RAIN RFID Alliance compliant ID type, a QR code, or other scannable IDs. Passive RFID or barcodes may require that an integrity code be replaced by partial encryption.

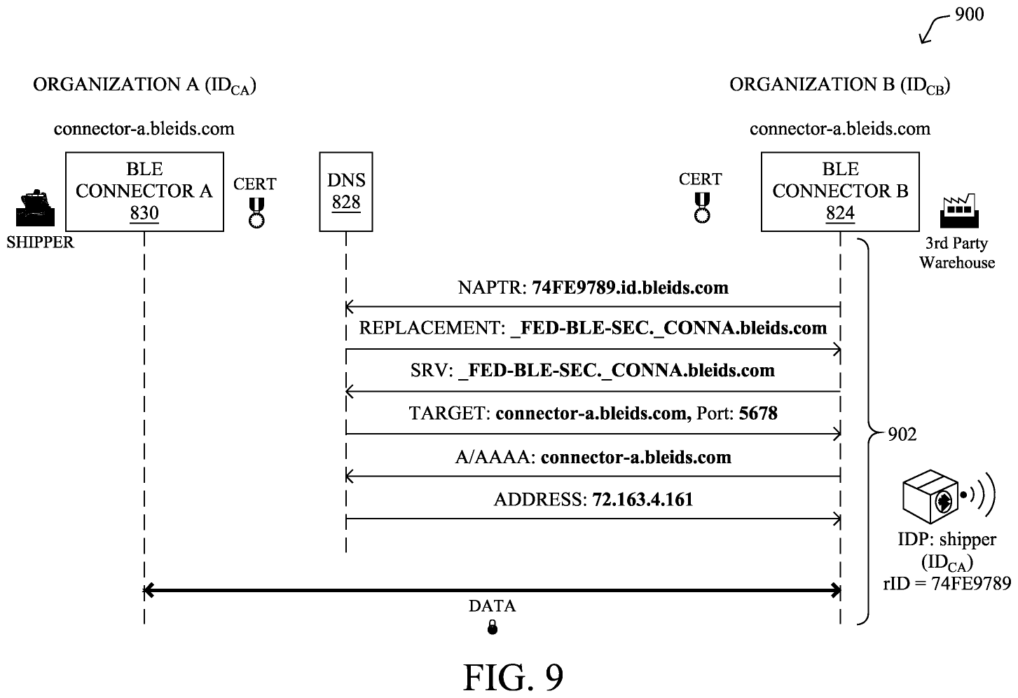

At step 820, one or more assets 804, including BLE tags/identifiers are shipped using one or more transport methods. Once one or more assets 804 reached the third-party warehouse 806, the corresponding BLE beacon(s) advertised by the BLE tag, at step 822, may be received by a BLE iBeacon infrastructure (e.g., an access point), which may be made available to a connector 824 associated with third-party warehouse 806. Connector 824 may parse the ID in the BLE iBeacon, and it may recognize it as an open roaming compatible ID (e.g., based on a prefix or preamble encoded in the UUID/major/minor fields in a payload of the beacon). Connector 824 may then extract a range, rID_{CA}, from the UUID/major/minor fields in the payload and, at step 826, query a DNS 828 to dynamically discover corresponding endpoint for a connector 830 of shipper 802. An example DNS-based query and response process to discover shipper 802 and its corresponding connector using DNS 828 are described in FIG. 9. At step 826, DNS 828 may also return information resulting from dynamic discovery of the connector 824, for example, a tuple (e.g., comprising: Service, FQDN and PORT) that enables connector 824 to dynamically establish a secure communication channel with shipper 802 (e.g., using a mutual TLS tunnel as defined by WBA OpenRoaming™)

After completion of the DNS lookup at step 832, connector 824 (of third-party warehouse 806) may establish a communication channel with connector 830 (of shipper 802). Using this communication channel, the connector 824 (of third-party warehouse 806) may forward, for example, iBeacons to shipper 802 that was dynamically discovered at step 826 (or information indicative of the iBeacons). It is contemplated that not every iBeacon might need to be forwarded. For instance, connector 824 may only forward a first beacon received, thereby enabling the identification of the item ID (e.g., iID) as well as verification of an integrity code by shipper 802. In this instance, additional beacons may be forwarded to the shipper 802 based on one or more policies, for example, of shipper 802 or third-party warehouse 806, One policy may be requiring the additional beacons when changes in one or more states of an asset to which the beacon is attached to has changed.

Connector 830 of shipper 802, at step 834, may in addition to being configured to enable verification of the item ID (e.g., iID) contained in the message also be configured is to perform one or more integrity checks of the iBeacon received from connector 824 of third-party warehouse 806. Such integrity checks may be implemented by a connector itself or an external process. For example, connector 830 of shipper 802 may retrieve and use a key K associated to the tuple that it received (rID_{CA}, iID), compute the same function executed by a BLE device on a header of the iBeacon, then compare the integrity code with one received in the frame forwarded by connector 824 of third-party warehouse 806. In the case where the results match, the message may be deemed as authentic, where information (from the message) may, at step 836, be forwarded to an application 838 of shipper 802 (e.g., a RTLS used by the shipper). In the case where the results do not match, the connector 830 of shipper 802 may, at step 840, be configured to notify connector 824 of third-party warehouse 806 of the failed match (i.e., an issue). Upon receiving notice of the failed match/issue, connector 824 of third-party warehouse 806 may, at step 842, be configured to notify the open roaming registry service 502 (e.g., through accounting information sent to fairness controller 606 of open roaming registry service 502). Additionally, in this case, connector 824 of third-party warehouse 806 may also discard subsequent advertisements from BLE iBeacon associated with one or more assets 804, since, according to shipper 802, the tag may have been compromised or cloned to link a parcel to shipper 802, even though the parcel might not be associated to or sent by shipper 802.

It is contemplated, that after step 834 (verification of the item ID and one or more integrity checks), connector 824 of third-party warehouse 806 and connector 830 of shipper 802 may be configured to exchange additional information (e.g. metadata) in a bidirectional manner. Notably, such information may encode/indicate the successful verification of the beacon, notifications (e.g., such as arrival, departure, status, etc. of the one or more assets 804 to or from third-party warehouse 806), detailed information regarding one or more assets 804, geolocation information regarding one or more assets 804, etc. In some embodiments, connector 824 of third-party warehouse 806 may also establish communications with other members of the supply chain, over for example, identity federation and visibility system/service 602. For example, once the is device/tag/identifier affixed to one or more assets 804 is recognized, a notification of arrival message might be sent upstream and/or downstream from connector 824 based on one or more policies of shipper 802, one or more assets 804, other stakeholders in the supply chain, etc. Specifically, it is contemplated such notification may be communicated on a point-to-point or a point-to-multi-point basis (i.e., 1:1 or 1:n).

As previously described, connector 824 of third-party warehouse 806 may also be configured to send one or more accounting feeds of information to fairness controller 606 of open roaming registry service 502. Information for these feeds may include a range (e.g., rID_{CA}) that identifies shipper 802 and/or third-party warehouse 806 (e.g., ID_{CB}) as well as additional information and/or metadata regarding one or more assets 804. In one or more embodiments, connector 824 of third-party warehouse 806 may also be configured to send early signals (e.g., information) of accounting to the fairness controller 606 (that is, concurrently to step 832). These early signals may be sent prior to the information sent during step 840 (e.g., that indicates whether there is failed match for iBeacon information). Fairness controller 606 may be configured to analyze this information to determine whether suspicious actions may have occurred along the supply chain that shipper 802 and third-party warehouse 806 are part of. For example, such information may be used to determine whether domains that are part of the supply chain that may be receiving the beacons from the access or scanning networks but are not confirming ownership of the corresponding identifiers. Such information may, alternatively, be used to detect and log attempts to clone identifiers (e.g., included as part of iBeacons).

FIG. 9 illustrates an example DNS resolution process 900 for enabling dynamic discovery of an identity provider and associated connector. As described herein above, connector registrar 612 of open roaming registry service 502 may be configured to create and/or manage rID-to-connector mappings. As shown in FIG. 9, shipper (e.g., Organization A 802) may have been assigned the range rID=74FE9789, which may be part of the identifier carried in a BLE iBeacon scanned at third-party warehouse (e.g., Organization B 806). A DNS lookup 902 may be triggered by the connector 824 of third-party warehouse 806, when this latter receives the BLE beacon and extracts the range identifier rID=74FE9789 from a header of the iBeacon header.

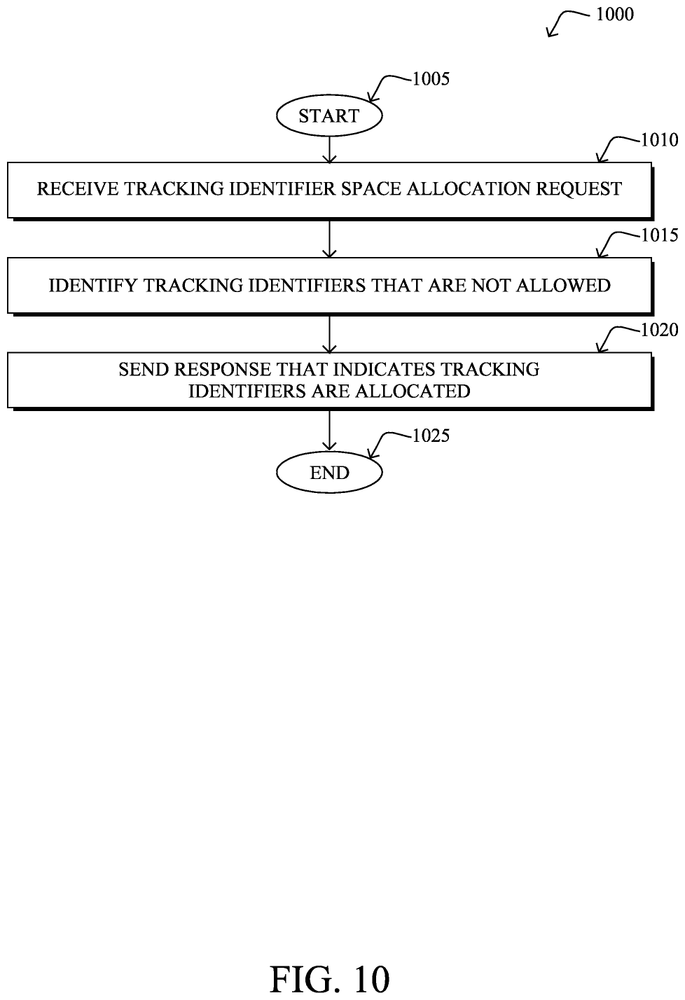

FIG. 10 illustrates an example simplified procedure for cross-organization tracking identifier space allocation for supply chains, in accordance with one or more embodiments described herein. In various embodiments, a non-generic, specifically configured device (e.g., device 200 in FIG. 2) may perform procedure 1000 by executing stored instructions (e.g., process 248 and process 249 in FIG. 2), to provide cross-organization tracking identifier space allocation for supply chains. The procedure 1000 may start at step 1005, and continues to step 1010, where, as described in greater detail above, a device may receive, from a client at a first organization, a tracking identifier space allocation request for one or more physical assets. For instance, the tracking identifier space allocation request may indicate that the client is configured to participate in a cross-organization asset tracking. In some embodiments, the tracking identifier space allocation request comprises one or more of: a unique identifier associated with the first organization, a technology type indicator, information regarding the client at the first organization, or a range size. The client at the first organization may comprise a plugin configured to communicate with one or more devices of the first organization that monitor delivery status and environmental measurements of the one or more physical assets. As would be appreciated, the organizations may be participating in an identity federation and visibility as a service program, as described in greater detail herein to manage and monitor supply chain(s) across organizations. Furthermore, in some embodiments, the client may be deployed at a seaport terminal, an airport, a transport vehicle, a warehouse, or a distribution center

At step 1015, as detailed above, the device may identify, based on the tracking identifier space allocation request, a range of tracking identifiers that are not allocated to one or more other organizations for use. In some embodiments, the device may identify the range of tracking identifiers that may be allocated to the one or more other organizations for use based on a fairness function. Further, as would be appreciated, in some embodiments, the device may register that the range of tracking identifiers that are is now allocated to the first organization in a domain name system.

At step 1020, the device may send, to the client at the first organization, a tracking identifier space allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations. As would be appreciated, the one or more physical assets may be tagged with tracking identifiers from the range of tracking identifiers using radio-frequency identification, Bluetooth, barcodes, or quick response codes. In some embodiments, the first organization may tag the one or more physical assets with one or more of: prefix, preamble, a range identifier, an item identifier, a nonce, or a suffix carrying an integrity code

In some embodiments, the second organization from the one or more other organizations may verify the one or more physical assets tagged with tracking identifiers based on communication with a domain name system. In one or more embodiments, the first organization from the one or more other organizations may perform one or more integrity checks on the one or more physical assets tagged with tracking identifier. Additionally, the second organization from the one or more other organizations may send a notification to the first organization based on receiving the one or more physical assets tagged with tracking identifiers Procedure 1000 then ends at step 1025.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for cross-organization tracking identifier space allocation for supply chains. One of the main advantages of the techniques herein is that it requires neither a central identity federation provider, nor waiting for a network effect. Indeed, just a small group of parties/organizations can create a federation and start benefiting from its use, immediately. In addition, the techniques herein provide improved visibility of assets and inventory across multi-organization supply chains in a controlled way, such as by enabling policy-driven data exchange between supply chain members using trusted digital identities and enabling private identity: federations between supply chain members. The techniques herein, by leveraging identity federation and visibility service(s) within a supply chain, enable the tracking of assets, goods, shipments, inventory, etc. across different organizations without depending on a single, oftentimes proprietary, tracking technology that is deployed end-to-end in a supply chain. That is the techniques herein are able to automatically allocate collision-free address spaces (e.g., tracking identifiers), while guaranteeing fair use of the identifier address space by various organizations of a given supply chain. For example, the identifier space allocation may be deployed in environments where non-roaming, potentially proprietary, asset/inventory tracking technologies are used (e.g., healthcare environments).

While there have been shown and described illustrative embodiments for a supply chain, it is to be understood that various other adaptations and modifications may be made within the intent and scope of the embodiments herein. For example, while specific types of identification technologies are described herein (e.g., RFID, BLE, etc.), the techniques herein are not limited as such and can be applied to any form of identification technology. Further, while the techniques herein are described primarily with respect to federating item identities and providing item visibility as well as across a supply chain, the techniques herein are not limited as such and can also be extended to federating workforce identity and visibility, connected asset identity and visibility, and the like.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable is medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
receiving, at a device and from a client at a first organization, a tracking identifier space allocation request for one or more physical assets;
identifying, by the device and based on the tracking identifier space allocation request, a range of tracking identifiers that are not allocated to one or more other organizations for use; and
sending, by the device and to the client at the first organization, a tracking identifier space allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations.

2. The method as in claim 1, wherein the tracking identifier space allocation request comprises one or more of: a unique identifier associated with the first organization, a technology type indicator, information regarding the client at the first organization, or a range size.

3. The method as in claim 1, wherein identifying the range of tracking identifiers that could be allocated to the one or more other organizations for use is based on a fairness function.

4. The method as in claim 1, further comprising:
registering, by the device, that the range of tracking identifiers are now allocated to the first organization in a domain name system.

5. The method as in claim 1, wherein the one or more physical assets are tagged with tracking identifiers from the range of tracking identifiers using radio-frequency identification, Bluetooth, barcodes, or quick response codes.

6. The method as in claim 1, wherein the second organization from the one or more other organizations verifies the one or more physical assets tagged with tracking identifiers based on communication with a domain name system.

7. The method as in claim 1, wherein the second organization from the one or more other organizations sends a notification to the first organization based on receiving the one or more physical assets tagged with tracking identifiers.

8. The method as in claim 1, wherein the client at the first organization performs one or more integrity checks on the one or more physical assets tagged with tracking identifiers.

9. The method as in claim 1, wherein the first organization tags the one or more physical assets with one or more of: prefix, preamble, a range identifier, an item identifier, or a nonce.

10. The method as in claim 1, wherein the client at the first organization is deployed at a seaport terminal, an airport, a transport vehicle, a warehouse, or a distribution center.

11. An apparatus, comprising:
one or more interfaces;
a processor coupled to the one or more interfaces and configured to execute one or more processes; and
a memory configured to store a process that is executable by the processor, the process when executed configured to:
receive, from a client at a first organization, a tracking identifier space allocation request for one or more physical assets;
identify, based on the tracking identifier space allocation request, a range of tracking identifiers that are not allocated to one or more other organizations for use; and
send, to the client at the first organization, a tracking identifier space allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations.

12. The apparatus as in claim 11, wherein the tracking identifier space allocation request comprises one or more of: a unique identifier associated with the first organization, a technology type indicator, information regarding the client at the first organization, or a range size.

13. The apparatus as in claim 11, wherein to identify the range of tracking identifiers that could be allocated to the one or more other organizations for use is based on a fairness function.

14. The apparatus as in claim 11, the process when executed further configured to:
register that the range of tracking identifiers are now allocated to the first organization in a domain name system.

15. The apparatus as in claim 11, wherein the one or more physical assets are tagged with tracking identifiers from the range of tracking identifiers using radio-frequency identification, Bluetooth, barcodes, or quick response codes.

16. The apparatus as in claim 11, wherein the second organization from the one or more other organizations verifies the one or more physical assets tagged with tracking identifiers based on communication with a domain name system.

17. The apparatus as in claim 11, wherein the second organization from the one or more other organizations sends a notification to the first organization based on receiving the one or more physical assets tagged with tracking identifiers.

18. The apparatus as in claim 11, wherein the first organization from the one or more other organizations performs one or more integrity checks on the one or more physical assets tagged with tracking identifiers.

19. The apparatus as in claim 11, wherein the first organization tags the one or more physical assets with one or more of: prefix, preamble, a range identifier, an item identifier, or a nonce.

20. A tangible, non-transitory, computer-readable medium storing program instructions that cause a device to execute a process comprising:
receiving, at the device and from a client at a first organization, a tracking identifier space allocation request for one or more physical assets;
identifying, based on the tracking identifier space allocation request, a range of tracking identifiers that are not allocated to one or more other organizations for use; and
sending, to the client at the first organization, a tracking identifier space allocation response that indicates the range of tracking identifiers that are now allocated to the first organization, wherein the first organization, after receiving the tracking identifier space allocation response, sends the one or more physical assets tagged with tracking identifiers from the range of tracking identifiers to a second organization from the one or more other organizations.
